(19) United States
(12) Patent Application Publication
(10) Pub. No.: US 2017/0259369 A1
(43) Pub. Date: Sep. 14, 2017

(54) Handheld Stud/Washer Welder

(71) Applicants: Bosjob Company Ltd., Jiangmen City (CN); Nu-Tec Systems, LLC, Mooresville, NC (US)

(72) Inventors: Liang-huan WENG, Jiangmen City (CN); Min-hsiang WENG, Jiangmen City (CN)

(21) Appl. No.: 15/452,145

(22) Filed: Mar. 7, 2017

(30) Foreign Application Priority Data
Mar. 8, 2016 (CN) 201620175230.6

(51) Int. Cl. B23K 9/10

(52) U.S. Cl. CPC B23K 9/1081

(57) ABSTRACT

A handheld stud/washer welder that includes a welder head having one or more of the capabilities of grounding, adjusting pressure on the welder head, and direct pulling after welding. An exemplary embodiment includes a welder body and a welder head located in front of the welder body that is electrically conductive and flexibly movable and configured to allow a user to change pressure between the welder head and the subject to be welded.

### FIELD OF THE INVENTION

The present disclosure relates to a stud/washer welding device, in particular to a handheld stud/washer welder, and more particularly to a welder head structure of the handheld stud/washer welder.

### BACKGROUND

The welder head of an existing handheld stud/washer welder is fixed on a welder body, the pressure between the welder head and the subject to be welded is not adjustable. After spot welding with the welder head, the welding point can't be directly pulled, an additional puller is needed, so that working efficiency is low. In addition, when welding with an existing handheld stud/washer welder, it needs an additional grounding wire connected with the subject to be welded to form an electrical circuit.

### SUMMARY OF THE DISCLOSURE

In one aspect, the present disclosure is directed to a handheld stud/washer welder that includes: a welder body including a capacitor and a power switch component which controls the charging and discharging of the capacitor, and a welder head located in front of the welder body, wherein the welder head comprises an adjusting screw rod, a nut and a spring, the nut and the spring are installed on the adjusting screw rod, the nut is at least partially located within the welder body, such that the length of the spring is adjustable by revolving the nut, in order to change pressure of a welding point.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 shows a welder head structure of a handheld stud/washer welder of an embodiment according to the present application;

FIG. 2 shows a welder body structure of the handheld stud/washer welder according to the present application;

FIG. 3 shows a welder head structure of the handheld stud/washer welder of a further embodiment according to the present application;

FIG. 4 is a bottom view of the welder head structure of FIG. 3; and

FIG. 5 schematically shows a welder controller and key electronic components inside the welder body structure of FIG. 2.

### DETAILED DESCRIPTION

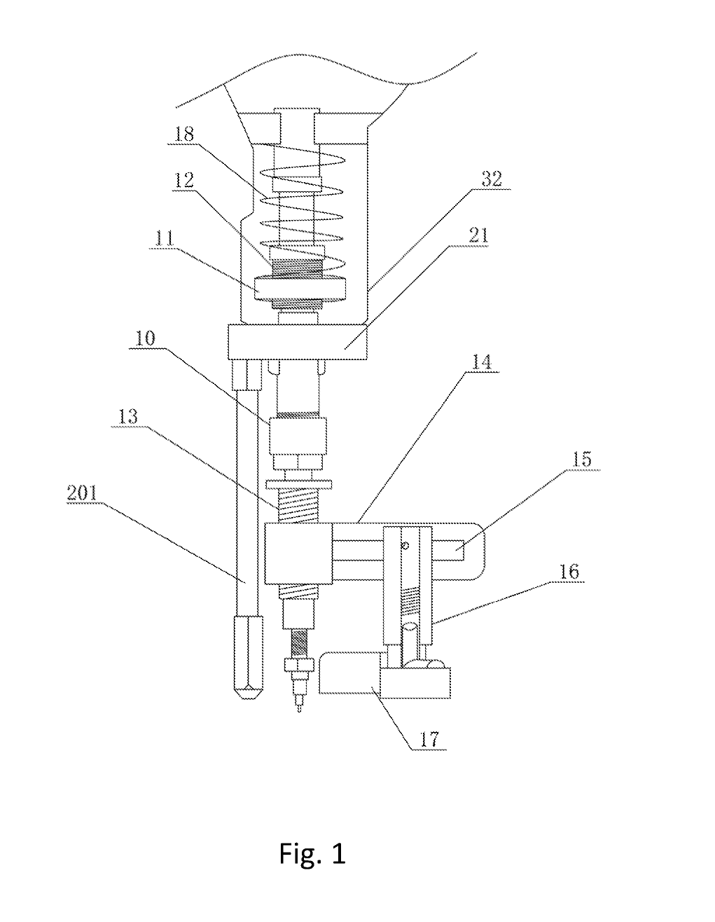

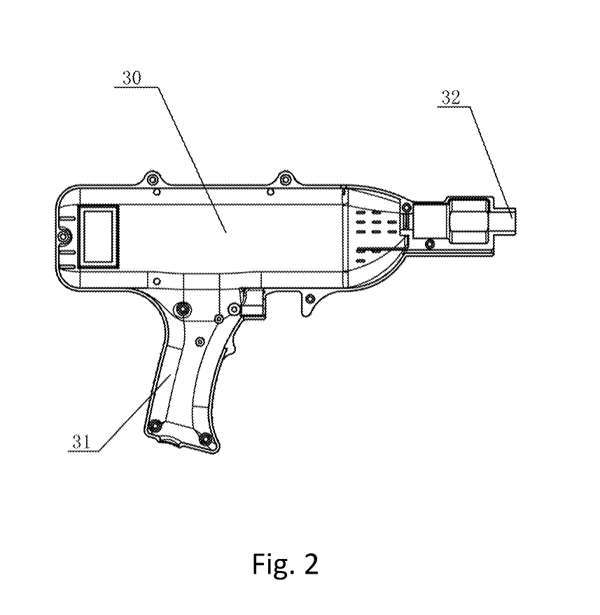

In order to solve the problem mentioned in the Background section above, the present disclosure provides, among other things, a handheld stud/washer welder that includes a welder head having capabilities of grounding, adjusting pressure on the welder head, and direct pulling after welding. Referring to FIG. 1 and FIG. 2, an exemplary welder head structure of the handheld stud/washer welder according to the present disclosure will be described in detail. In this embodiment, the handheld stud/washer welder comprises a welder head 10 and welder body 30.

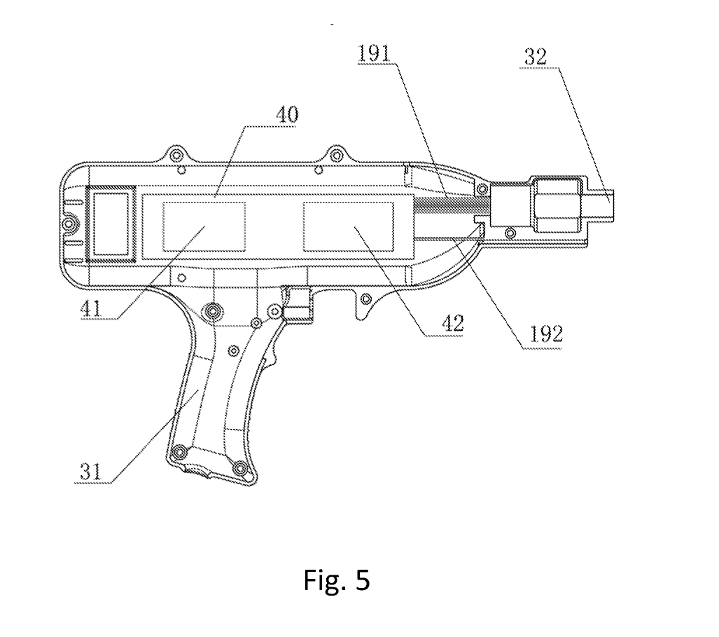

In an embodiment, the welder body 30 is provided with a handle 31 and nozzle 32. As shown in FIG. 5, the welder body comprises a capacitor 42, and a power switch component 41, such as a MOSFET, which controls the charging and discharging of the capacitor 42. The welder head 10 is installed on the nozzle 32 in the front end of the welder body 30. The welder head 10 comprises an adjusting screw rod 12. A nut 11 and a spring 18 are installed on the adjusting screw rod 12. The nut 11 is at least partially located within the welder body 30, such that the length (thus the compression) of the spring 18 is adjustable by revolving the nut 11. For example, the nut 11 can be partially out of the welder body so that it's accessible by a user, then he can revolve the nut 11 conveniently and adjust the compression of the spring 18, so as to change pressure between the welder head 10 and the subject to be welded, and thus pressure applied on a welding point. Optionally, the user can revolve the nut 11 with his non-dominant hand rather than his dominant hand.

Preferably, due to the compressible spring 18, the welder head 10 can be elastically installed on the welder body 30. In this way, the welder head 10 can elastically press on the subject to be welded, preventing the welder head 10 and the subject to be welded from being damaged, and maintaining a minimum attrition rate to the welder head 10.

The welder head 10 is further provided with an installing screw rod 13, the installing screw rod 13 is connected with a horizontal support 14. The horizontal support 14 is provided with an oblong hole 15. A vertical support 16 is hinged with the horizontal support 14 through the oblong hole 15 by a pin shaft. The vertical support 16 is connected with a pedestal 17 at the lower end of the vertical support 16. Preferably, the pedestal 17 is in an arc shape when viewed from top of a welding surface. When welding, the pedestal 17 seats against the subject to be welded and functions as a support, then the welder can be directly pulled up with use of the vertical support 16 after welding.

In another embodiment, different kinds of tools can be installed on the welder head 10. Such tools may comprise chucks or welding jigs (or it may called welding heads). A stud and/or washer can be loaded in the chuck and efficiently planted and welded, for example, on the subject to be welded. The welding jig may comprise the installing screw rod 13. The horizontal support 14, the vertical support 16 hinged with the horizontal support 14 and the pedestal 17 constitute a support module in “h” shape. When welding, a user holds the welder body by resting the support module against the base material (i.e. welding surface). After welding, the support module could work as a pivot for directly pulling, from the base material.

In another embodiment, the distance between the welding point/tool and the support module can be changed by adjusting the horizontal position of the vertical support 16 on the horizontal support 14, such that, but not limited to, a pulling force can be fine-tuned, and a suitable supporting can be realized. Preferably the vertical support 16 is maintained in parallel with the tool.

Preferably, as shown in FIGS. 1, 3 and 4, at least one earth leg 201, 202 parallel to a longitudinal axis of the welder head 10 is provided on the front end of the welder body 30. The earth leg 201, 202 is detachably installed in the front end of the welder body 30, to provide for convenient replacement. Since the earth leg 201, 202 parallel to the welder head 10 is provided on the welder body 30, an additional grounding arrangement or grounding wire is not necessary, which improve the efficiency. Specifically, the earth leg 201, 202 is a grounding component. The earth leg 201, 202, the welder head 10, and the base material (i.e. welding surface, preferably metal) can constitute an electrical circuit, preferably via an electrical conductor within the welder body 30.

Preferably, the welder head 10 may further comprise an earth base 21, which may have a hole to connect with the earth leg 201, 202. The earth leg 201, 202 and welder head 10 are in parallel, and the earth leg 201, 202 can be a grounding leg. Therefore, extra earth cable can be eliminated when a user uses the handheld stud/washer welder according to the present disclosure. The earth base 21 can be arranged between the nut 11 and the installing screw rod 13.

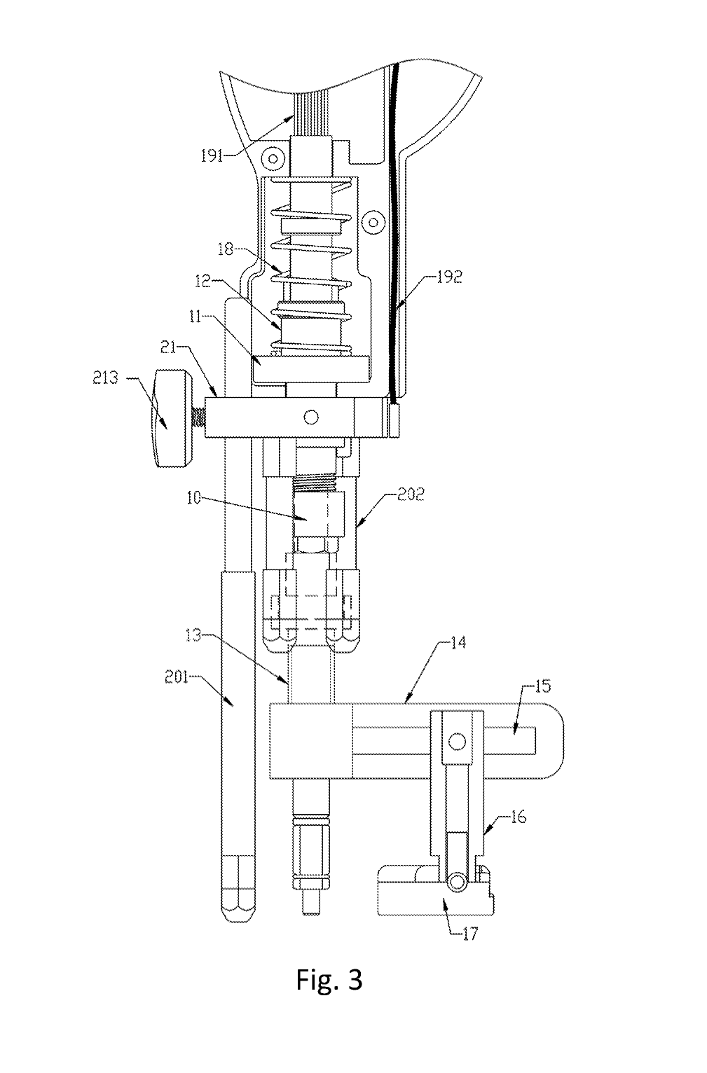

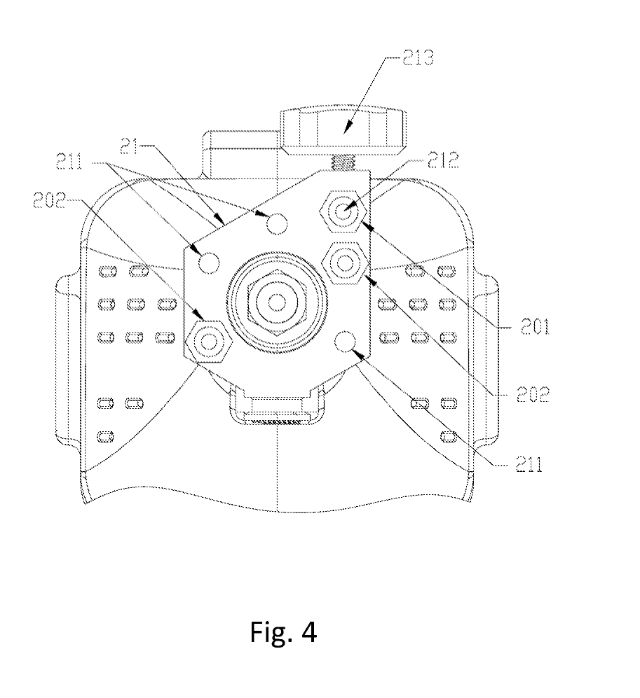

In a further embodiment, as shown in FIGS. 3 and 4, which is based on and modified from the above embodiments, the welder head 10 is connected with an internal electrical conductor 191, such that the welder head 10 is electrically conductive and flexibly movable. Likewise, the earth leg 201, 202 is connected with an internal earth conductor 192. In a further embodiment, as schematically shown in FIG. 5, the internal electrical conductor 191 and the internal earth conductor 192 can be respectively connected to a welder controller 40. The welder controller 40 may comprise any electronic and electrical component necessary to operate the welder, such as a printed circuit board (PCB), the power switch component(s) 41, and capacitor(s) 42, etc. The conductor can be fabricated as an electrical conductive cable, such that the welder head 10, earth leg 201, 202, conductors 191, 192 and welder controller 40 constitute an electrical circuit.

In the further embodiment, the at least one earth leg 201, 202 comprises at least one longer earth leg 201 and at least one shorter earth leg 202. The welder head 10 further comprises an earth base 21, wherein the earth base 21 is provided with at least one hole to respectively install and fix each earth leg 201, 202. Preferably, each earth leg 201, 202 is detachably installed in a corresponding hole on the earth base 21, and/or the earth base 21 is further provided with an adjuster for adjusting the protruding length of at least one of the earth leg 201, 202 from the earth base 21.

In particular, as shown in FIG. 4, several threaded holes 211 are provided on the bottom surface of the earth base 21. As shown in FIG. 4, two shorter earth legs 202 are threaded into the threaded holes 211 and installed on the earth base 21. It should be appreciated that more threaded holes 211 can be provided, more or fewer earth legs 201, 202 can be provided (more earth legs 201, 202 can be used at the same time for better grounding performance), positions of earth legs 201, 202 can be changed, for different applications. It should be also appreciated that the threaded hole can be suitable for longer or shorter earth legs.

In particular, as shown in FIG. 3, the adjuster comprises an adjusting screw 213, arranged in a further threaded hole on the side of the earth base 21, orthogonal and communicates with a further through hole 212 in which a longer earth leg 201 is slidably installed, to release or engages with the longer earth leg 201 by releasing or tightening the adjusting screw 213, in order to adjust the protruding length of the longer earth leg 201 from the earth base 21. Wherein the further through hole 212 is provided on the bottom surface. In practice, when a user needs to use a shorter earth leg 202 rather than a longer one, optionally he doesn't need to detach the longer earth leg 201 installed in the further through hole 212, instead he can adjust and shorten the protruding length thereof, so that the longer earth leg 201 will not interfere with the shorter earth leg 202.

Preferably, at least two earth legs 201, 202 are arranged symmetrically around the welder head 10, and having a same protruding length from the earth base 21. As shown in FIG. 4, two shorter earth legs 202 are arranged symmetrically around the center of the welder head 10, the distance from each shorter earth leg 202 to the center is the same, such that, arc bias (or referred to as arc deflection) can be avoided, when a user proceeds electric-arc welding with an aluminium stud or a capacitive aluminium stud.

In practice, as an example, it's advantageous to use different earth legs 201, 202 for different welding surfaces, such as iron steel or aluminum alloy, in order to prevent different types of steel residues from attaching on a same earth leg 201, 202.

Therefore, a user can replace with different earth legs 201, 202 with different lengths, or with fewer or more earth legs 201, 202, or he can just adjust the protruding length of at least one of the earth legs 201, 202 from the earth base 21, for different usage.

Advantages of embodiments of the present disclosure include the following:

The welder head of the handheld stud/washer welder is provided with an adjusting screw rod and a nut for adjustment, such that the length of the spring is adjustable by revolving the nut, in order to change pressure between the welder head and the subject to be welded, and thus pressure applied on a welding point.

In addition, the welder head is further provided with a horizontal support, a vertical support hinged with the horizontal support and a pedestal. These three components constitute and work as a support module in “h” shape, when the pedestal seats against the subject to be welded in a welding process. The welder can be directly pulled up after welding, i.e. from a welding surface, with use of the support module. At least one earth leg parallel to the welder head is provided on the front end of the welder body, such that additional grounding wire is not necessary, which improves the efficiency.

A stud and/or washer can be efficiently planted and welding by use of the handheld stud/washer welder according to the present disclosure, wherein such welding can be spot welding. Spot welding followed by a direct pulling can be realized by use of the handheld stud/washer welder according to the present disclosure. The handheld stud/washer welded according to the present disclosure can be used, for example, in car repairing, steel plate welding, stud/washer planting and welding, spot welding.

The foregoing has been a detailed description of illustrative embodiments of the invention. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A handheld stud/washer welder, comprising:
a welder body including a capacitor and a power switch component which controls the charging and discharging of the capacitor, and
a welder head located in front of the welder body, wherein:
the welder head comprises an adjusting screw rod, a nut and a spring;
the nut and the spring are installed on the adjusting screw rod; and
the nut is at least partially located within the welder body, such that the length of the spring is adjustable by revolving the nut, in order to change pressure of a welding point.

2. The handheld stud/washer welder according to claim 1, wherein the welder head is further provided with an installing screw rod, the installing screw rod is connected with a horizontal support, the horizontal support is connected with a vertical support, the vertical support is connected with a pedestal.

3. The handheld stud/washer welder according to claim 2, wherein the horizontal support is provided with an oblong hole, the vertical support is hinged with the horizontal support through the oblong hole by a pin shaft.

4. The handheld stud/washer welder according to claim 1, wherein at least one earth leg parallel to the welder head is provided on the front end of the welder body.

5. The handheld stud/washer welder according to claim 4, wherein the earth leg is detachably installed in the front end of the welder body.

6. The handheld stud/washer welder according to claim 1, wherein the power switch component comprises a MOSFET.

7. The handheld stud/washer welder according to claim 3, wherein the distance between a tool installed on the welder head and the support module is changed by adjusting the horizontal position of the vertical support on the horizontal support.

8. The handheld stud/washer welder according to claim 7, wherein the tool comprises a chuck or welding head.

9. The handheld stud/washer welder according to claim 1, wherein the welder head is connected with an internal electrical conductor, such that the welder head is electrically conductive and flexibly movable.

10. The handheld stud/washer welder according to claim 4, wherein the earth leg is connected with an internal earth conductor.

11. The handheld stud/washer welder according to claim 4, wherein at least two earth legs are arranged symmetric around the welder head.

12. The handheld stud/washer welder according to claim 4, wherein the welder head further comprises an earth base, the earth base is provided with at least one hole to respectively install and fix each earth leg.

13. The handheld stud/washer welder according to claim 12, wherein the earth base is further provided with an adjuster for adjusting the protruding length of at least one of the earth legs from the earth base.

14. The handheld stud/washer welder according to claim 13, wherein the adjuster comprises an adjusting screw, arranged in a further threaded hole of the earth base that is orthogonal to and communicates with the hole in which the earth leg is installed, the adjusting screw for releasably holding the earth leg in place.

15. The handheld stud/washer welder according to claim 9, wherein the internal electrical conductor comprises an internal electrical cable connected with a welder controller, wherein the welder controller includes the power switch component.

16. The handheld stud/washer welder according to claim 10, wherein the internal earth conductor comprises an internal earth cable connected with a welder controller, wherein the welder controller includes the power switch component.

17. The handheld stud/washer welder according to claim 12, wherein the earth leg is detachably installed in the earth base.

18. The handheld stud/washer welder according to claim 2, wherein the earth base is arranged between the nut and the installing screw rod.

19. The handheld stud/washer welder according to claim 12, wherein at least two earth legs are arranged symmetric around the welder head, and having a same protruding length from the earth base.
